(19) United States
(12) Patent Application Publication
(10) Pub. No.: US 2009/0319943 A1
(43) Pub. Date: Dec. 24, 2009

(54) CHARACTER INPUT APPARATUS AND CHARACTER INPUT METHOD

(75) Inventor: Kwang-soo HA, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/369,137

(22) Filed: Feb. 11, 2009

(30) Foreign Application Priority Data
Jun. 18, 2008 (KR) 2008-57286

(51) Int. Cl. G06F 3/048; G06F 3/02

(52) U.S. Cl. 715/802; 345/168; 715/834

(57) ABSTRACT

A letter input apparatus includes an input unit having at least one direction key, a display unit to display a screen having a display area to display at least one letter capable of being input by the input unit and at least one input key to input letters, and a control unit to cause the letter displayed on the display area to be input or displayed.

### CROSS-REFERENCE TO RELATED APPLICATIONS

This application claims priority under 35 U.S.C. §119(a) from Korean Patent Application No. 2008-0057286, filed on Jun. 18, 2008, in the Korean Intellectual Property Office, the contents of which are incorporated herein by reference in its entirety.

### BACKGROUND OF THE INVENTION

1. Field of the Invention

The present general inventive concept relates to a character input apparatus and a character input method, and more particularly, to a character input apparatus in which characters are input on a narrow display and a character input method using the same.

2. Description of the Related Art

Display apparatuses generally provide various methods for inputting characters. The development in application software has made it possible to apply a character input method to a display apparatus using a soft keyboard.

A soft keyboard is a system that replaces the hardware keyboard on a display with an on-screen key board, and enables a user to conveniently input characters. If a soft keyboard is shown on a display, a user may input desired characters or numbers using an input device such as a remote controller or a joy stick.

A conventional soft keyboard uses the same arrangement as a hardware keyboard connected to a computer, and thus has a large number of buttons. Accordingly, the conventional soft keyboard occupies a large area on a display. Since information regarding the environment of desired input characters is not displayed, a user cannot confirm what character is input.

Keys constituting the corresponding characters on the keyboard are apart from one another, and thus when selecting characters using the remote controller, a user is inconvenienced by manipulating direction keys to search for and/or select desired characters.

As general soft keyboards occupy a wide display window, they are inconvenient to use on a narrow display window.

Accordingly, there is a need for methods for reducing the number of keys to be included to enable input using a compact key set.

### SUMMARY OF THE INVENTION

The present general inventive concept provides a character input apparatus to conveniently and rapidly input characters on a narrow display window, and a character input method.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a letter input apparatus, including an input unit including at least one direction key; a display unit to display a screen having a display area to display at least one letter capable of being input using the input unit and at least one input key to input letters, and a control unit to cause the letter displayed on the display area to be input or displayed.

The input unit may further include an input unit including a first key to change a letter displayed on the display area, and to select the at least one input key, and a second key to confirm the letter displayed on the display area or the input key selected by the first key.

If the first key is manipulated while a specific mode is selected, the control unit may control the display unit to display at least one letter supported by the specific mode on the display area according to the direction or number of times the first key is manipulated, and if the second key is manipulated while a specific letter is displayed on the display area, the specific letter may be input.

The input unit may include four direction keys, and if a direction key corresponding to a direction in which the display area and the input keys are arranged is selected from among the four direction keys, the control unit may move a focus to one of the display area and the at least one input key according to the selected direction.

If a direction key perpendicular to the direction in which the display area and the input keys are arranged is selected from among the four direction keys, the control unit may change the letter displayed on the display area.

If a one-time menu is selected while the focus is positioned on the one-time menu among menus for the at least one input key, the control unit automatically returns the focus to the display area, and if a repetitive menu is selected while the focus is positioned on the repetitive menu among menus for the at least one input key, the control unit may keep the focus on the current position.

The input unit may include a search wheel, and the control unit changes a letter displayed on the display area according to the roll of the search wheel, or selects the at least one input key.

The display unit may include a screen on which the letter selected on the display area and a cursor indicating the position of the selected letter are displayed.

If conditions to input a letter are provided, the control unit may automatically call for a screen on which the display area and the at least one input are arranged.

The foregoing and/or other aspects and utilities of the present general inventive concept may be achieved by providing a letter input method of a letter input apparatus, the method including displaying a screen including a display area to display at least one letter capable of being input by the input unit and at least one input key to input letters, and inputting or displaying a letter displayed on the display area according to a user command.

The inputting or displaying may include inputting or displaying a letter displayed on the display area according to manipulation of at least one of a first key to change a letter displayed on the display area, and to select the at least one input key and a second key to confirm the letter displayed on the display area or the input key selected by the first key.

If the first key is manipulated while a specific mode is selected, the inputting or displaying may display at least one letter supported by the specific mode on the display area according to the direction or number of times the first key is manipulated, and if the second key is manipulated while a specific letter is displayed on the display area, the inputting or displaying may input or display the specific letter.

The method may further include displaying a focus on at least one of the display area and the at least one input key; and if a direction key corresponding to a direction in which the display area and the input keys are arranged is selected from among the four direction keys provided on the letter input apparatus, moving a focus according to the selected direction.

The method may further include changing the letter displayed on the display area if a direction key perpendicular to the direction in which the display area and the input keys are arranged is selected from among four direction keys.

The method may further include if a one-time menu is selected while the focus is positioned on the one-time menu among menus for the at least one input key, automatically returning the focus to the display area, and if a repetitive menu is selected while the focus is positioned on the repetitive menu among menus for the at least one input key, keeping the focus on the current position.

The inputting or displaying may include changing a letter displayed on the display area according to the roll of a search wheel provided on the letter input apparatus, or selecting the at least one input key in order to input or display the letter.

The method may further include displaying the letter selected on the display area and a cursor indicating the position of the selected letter on the screen.

If conditions to input a letter is provided, automatically calling for a screen on which the display area and the at least one input are arranged.

The display area and the at least one input key may be disposed horizontally or vertically on the screen.

The display area and the at least one input key may be displayed transparently or semi-transparently.

The positions of the display and the at least one input key may be swapped with each other.

The foregoing and/or other aspects and utilities of the present general inventive concept may be achieved by providing an apparatus including a letter input apparatus having an input unit comprising at least one direction key, a display unit to display a screen having a display area to display at least one letter capable of being input using the input unit and at least one input key to input letters, and a control unit to cause the letter displayed on the display area to be input or displayed, and a unit to perform an operation according to data corresponding to the input letter of the input apparatus.

The foregoing and/or other aspects and utilities of the present general inventive concept may be achieved by providing an input device including a display unit having a screen a first area to display at least one of characters, a second area to display a direction to indicate another one of the characters, and a third area to display at least one of the at least one and the another one of the characters, and an input unit having a first key to select the displayed direction and a second key to select the at least one character such that the third area of the display unit displays the selected at least one character.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an input device according to an exemplary embodiment of the present general inventive concept;

FIG. 2 is a block diagram illustrating an input device according to another exemplary embodiment of the present general inventive concept;

FIG. 3 is a schematic view illustrating an input device according to an exemplary embodiment of the present general inventive concept;

FIG. 4 is a view illustrating a display unit of the input device of FIG. 3;

FIGS. 5A to 5D are views provided to explain the arrangement of the first key and input keys according to various exemplary embodiments of the present general inventive concept;

FIGS. 6A to 6D are views provided to explain the exemplary embodiments of FIG. 5A to 5D in detail;

FIGS. 7A and 7B are views illustrating the focus movement according to an exemplary embodiment of the present general inventive concept;

FIGS. 8A to 8C are views provided to explain a character input method using four direction keys according to an exemplary embodiment of the present general inventive concept;

FIGS. 9A, 9B and 9C are views provided to explain a method for modifying input letters according to another exemplary embodiment of the present general inventive concept;

FIG. 10 a flowchart provided to explain a character input method according to an exemplary embodiment of the present general inventive concept; and

FIG. 11 is a flowchart provided to explain a character input method according to another exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

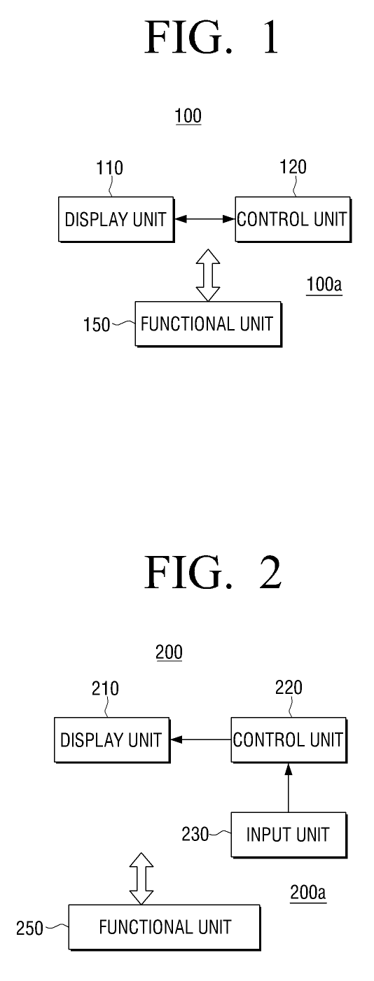

FIG. 1 is a block diagram illustrating an input device according to an exemplary embodiment of the present general inventive concept. Referring to FIG. 1, an input device 100 according to an exemplary embodiment of the preset general inventive concept may include a display unit 110 and a control unit 120.

The input device 100 is included in an apparatus 100a, for example, an image forming apparatus or various electronic devices 100a, and is used as an input means of the apparatus or devices. The image forming apparatus can have a functional unit 150 having a structure or elements to perform its own function or operation as, for example, a printer, a scanner, a copy machine, a fax machine, or a multi functional apparatus including at least two of the printer, scanner, copy machine, and fax machine, according to data (signal) input from the input device 100. It is also possible that the apparatus may be an image processing device having the input device 100 to process data input from the input device 100 and generate a signal from the processed data to display an image according to the signal, or a communication device (a wireless or cell phone device) having the input device 100 to communicate with another communication device according to data input from the input device 100. Since the structure, function and operation of the functional unit 150 of the image processing device and the communication device are well known, detailed descriptions thereof will be omitted.

The apparatus 100a may perform the operation according to data received from the control unit 120 through the display unit 110. It is also possible that the control unit 120 may have an interface to communicate with an external device to transmit and receive data to and from the external device such that the functional unit 150 can perform the above-described functions. When the apparatus 100a is an image forming apparatus, the structure of the functional unit 150 may include a feeding unit to feed a printing medium, an image forming unit to form an image on the printing medium according to data input through the display unit 110 or processed by the control unit 120, or according to data input from the external device or a scanning unit to scan a document to generate the data, and a discharge unit to discharge the printing medium. It is possible that the control unit 120 has an interface to communicate with an external device according to data input through the display unit 110.

The input device 100 may be a device suitable for an image forming apparatus which employs a narrow display window such as a single function printer. The narrow display window may not have a display space enough to display all letters to be input or all numbers to be input, but a limited display space to display a selected number of the all letters or all numbers. The desirable letters or numbers can be selected and/or displayed according to embodiments and utilities of the present general inventive concept, and detailed descriptions of the selected letters or numbers can be illustrated hereinafter.

If one or more characters are required to be input according to various functions provided by various devices using the input device 100, the display unit 110 includes a screen having a display area to display at least one character to be input and an area with one or more input keys to control the operation of inputting the character. The display unit 110 may be implemented using a liquid crystal display (LCD), a cathode ray tube (CRT), a plasma display panel (PDP), or an organic light emitting diodes (OLED). The display area and the input keys may mean areas which are occupied by menus or windows displayed on the screen of the display unit 110. The display area and the input keys may be arranged in various formats. Specifically, the display area and the input keys may be arranged in a single line or as a plurality of lines, arranged vertically, or arranged along an edge of the display.

The characters displayed in the display unit 110 may be one or more letters, one or more numbers, or a combination of one or more letters and one or more numbers.

The display area and at least one input key may be disposed horizontally or vertically.

The display area and at least one input key may be formed transparently or semi-transparently.

The position of the display area and at least one input key may be swapped with each other.

The display area and the input keys may overlap with each other at least a portion of the screen of the display unit 110.

The control unit 120 generates a signal to display the one or more characters on the display area to be input according to a user command.

The one or more characters to be input using the input device 100 may include various character sets, for example scripts such as Korean, English, Japanese, Chinese, Roman, or Greek, or numbers, symbols, figures, units, and rule marks.

The input keys may be an area on which various menus related to the character input are displayed in a soft key format. Specifically, the input keys include a mode conversion menu to change the type of letters, a cursor movement menu to move a cursor displayed on a display, a space key menu to enter a space between letters, and an OK menu to complete input.

FIG. 2 is a block diagram illustrating an input device 200 according to another exemplary embodiment of the present general inventive concept. Referring to FIG. 2, the input device 100 according to an exemplary embodiment of the present general inventive concept may include a display unit 210, a control unit 220, and an input unit 230. The input device 200 may be used in an apparatus 200a having a functional unit 250. The functional unit 250 of the apparatus 200a is similar to the functional unit 150 of the apparatus 100a. Elements illustrated in FIG. 2 which are also found in FIG. 1 will not be explained below. The control unit 220 may have an interface to communicate with an external device according to data input though the input unit 230 and the display unit 210.

The display unit 210 may display a screen having a display area and at least one input key in a soft keyboard format of an image map. That is, the display area and at least one input key may be displayed in a soft key format, respectively.

If the size of the display unit 210 is limited, the display area may display only one or more letter. However, the present general inventive concept is not limited thereto. It is possible that two or more letters may be displayed.

The input unit 230 may include at least one direction key, and may receive a user command. The input unit 230 may be implemented using various input means. Specifically, the input unit 230 may be implemented using a key panel having four direction keys or a scroll wheel capable of being scrolled.

The input unit 230 may also be implemented as a touch panel or a touch screen on a screen provided by the display unit 210.

The input unit 230 changes letters displayed on the display area, and includes at least one first key to select at least one input key, and a second key to confirm the letter displayed on the display area or the input key selected using the selection key.

If the first key is manipulated while a specific mode is selected, the control unit 220 controls the display unit 210 to display at least one letter supported in the specific mode on the display area according to the manipulation direction and the number of manipulations of the first key. If the second key is selected while a specific letter is displayed on the display area, the specific letter may be input.

If it is supposed that the input unit 230 is implemented using four direction keys, the control unit 220 moves a focus in a direction corresponding to the direction key selected by a user, and thus the user can navigate the first key and input keys displayed on the display.

More specifically, if a direction key corresponding to the direction in which the display area and the input keys are arranged is selected from among the four direction keys, the control unit 220 may generate a signal to move the focus from the current position in the selected direction. The focus represents a mark to move according to the selection of a user, and to indicate the first key or the input key.

The focus may be displayed as a focus ring which surrounds the circumference of the soft key, and may also be displayed differently from the other soft keys. For example, the focus may be formed by having a different color for each of the soft keys, by displaying a predetermined icon on one side of each of the soft keys, by changing the size of the focus, or by having flickering focus.

If a direction key which is different from the direction in which the input keys are arranged is selected from the four direction keys, the control unit 220 may change the letters displayed on the display area. In this case, the letters displayed on the display area are scrolled through in order according to the manipulation of the direction keys. If a user presses a specific direction key once while letter “A” is displayed, either letter “B” or “Z” is then displayed on the display area, and if a user presses a specific direction key three times while letter “A” is displayed, either letter “D” or “X” is displayed on the display area.

The focus may be set as default to be placed on the display area. Accordingly, the letter which a user desires to input may be selected first. A user selects one of the direction keys using the input unit 230 to change the letter displayed on the display area, or to move the focus to one of the input keys.

If the focus is positioned on a one-time menu among menus for at least one input key, and thus if the one-time menu is selected, the control unit 220 determines the function corresponding to the selected one-time menu to be performed, and generates a signal to control the focus to be automatically returned to the display area. The one-time menu can be, for example, a mode conversion menu to convert character set to be input.

If the focus is positioned on a repetitive menu among menus included in at least one input key, the control unit 220 generates a signal to control the focus to be maintained on the current position. That is, if the menu is capable of being selected repetitively, a user may select the menu again. Accordingly, the focus may continue positioning on the currently selected menu in order to prevent the focus from moving unnecessarily. The repetitive menu can be, for example, a menu to move the direction of a cursor or a space key.

The focus may be embodied in various forms. The focus is implemented in a focus ring form to highlight around a menu, which will be explained below.

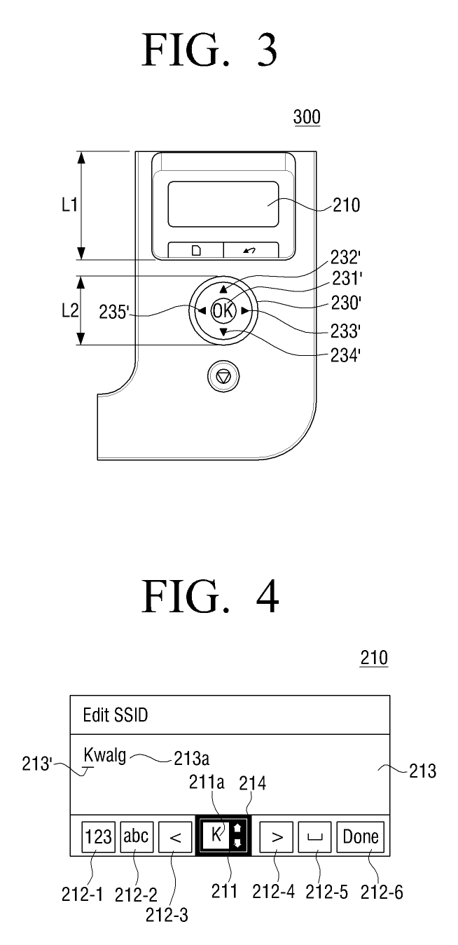

FIG. 3 is a schematic view illustrating an input device 300 according to an exemplary embodiment of the present general inventive concept. The input device 200 according to the exemplary embodiment of the present general inventive concept is implemented in the same manner as the input device 200 of FIG. 2 for convenience of description, and includes four direction keys.

The input device 300 may be used in an apparatus 300a, for example, an image forming apparatus. The apparatus 300a of FIG. 3 may be similar to the apparatus 200a having the functional unit 250 as illustrated in FIG. 2.

Referring to FIGS. 2 and 3, the input device 300 may include a display unit 210 and a portion of an input unit 230 having four direction keys 230′ (232′, 233′, 234′, and 235′) which are provided on a lower portion of the display unit 210, and an enter key, such as, an OK key 231′ to confirm the key moved by at least one of the four directional keys 230′. The input device 300 may further include a cancel key 240 which is separated from the four direction keys 230′. However, this is merely an exemplary embodiment of the present general inventive concept, and the cancel key 240 may be implemented as an aforementioned soft key.

If the conditions to input letters are not provided, a soft keyboard is not displayed on the display unit 210.

Here, the above-describe soft key, soft key format, soft keyboard format, or soft keyboard may represent a key or a key system to be displayed on a screen to be selected, compared to a hardware-type key formed on a housing to be moveable between selection and non-selection positions to select a function corresponding to the movement of the switch. Accordingly, a screen of a display unit according to the present embodiment can selectively display at least one of characters (letters and/or numbers), change the displayed character to another character, or to replace the display character with another character according to operations of the input unit 230 or the control unit 220 such that one or more number of characters can be selected by the input unit 230 as data which can be used to control the functional unit 250 and/or the control unit 220 to perform the desired operation of the apparatus 300a.

According to the present general inventive concept, an area of the display unit 210 is not enough to display all the characters, all numbers, all letters, or a combination of all of the letters and numbers. The area of the display unit 210 may have a limited space to display a limited number of characters among the available characters to be input. That is, the number of the characters and/or keys displayed in the display unit 210 is smaller than the number of the characters available to input using the display unit 210 and the input unit 230. It is possible that the display unit 210 can have a dimension, for example, a length L1, and the input unit 230 can have a dimension, for example, a length L2 in a direction on which the display unit 210 and the input unit 230 are disposed.

FIG. 4 is a view illustrating the display unit 210 of the input device 200 of FIG. 3.

Referring to FIGS. 2, 3 and 4, when the apparatus 300a is in a condition or mode to input letters, soft keyboards 211, 212-1 to 212-6 are displayed on the display unit 210.

The display area 211 represents a display area to display at least one letter which is capable of being input, and the soft keyboards 212-1 to 212-6 represent input keys to control the letter input.

A focus ring 214 is displayed around the circumference of the display area 211, which represents that the display area 211 is activated. The activation of the display area 211 means that a user may select a desired letter, for example, a letter 211a using the display area 211. The focus ring 214 may be a highlighted portion including the desired letter 211a compared to the soft keyboards 212-1 to 212-6.

The letters displayed on the display area 211 may be changed by manipulation of the up and down direction keys 232′ and 234′ among the four direction keys 230′.

The key “123” 212-1 represents a number mode key, and the key “abc” 212-2 represents a lowercase mode. The lowercase mode is displayed on the key “abc” 212-2 since capital letters are displayed on the display area 211. However, if lowercase letters are displayed on the display area 211, the uppercase mode is displayed on the key 212-2.

The keys “<” and “>” 212-3 and 212-4 represent left and right direction keys, and move a cursor 213′ on a letter display area 213. If a selection key, for example, the OK key 231′ at the center of the four direction keys 230 of FIG. 3, is input while the focus ring 211-1 is positioned around the key “<” 212-3, the cursor 213′ moves to the left of the input letters 213a with respect to the letter display area 213. When the focus ring 211-1 is positioned around the key “<” 212-4, and the OK key 231′ is selected, the cursor 213′ moves to the left of the input letters 213a with respect to the letter display area 213.

The key [symbol] 212-5 functions as a space key to provide a space within or at a position of the cursor 213′ with respect to the input letters 213a, and a key “Done” 212-6 is used to complete the letter input. If the key “Done” 212-6 is selected, a current menu having a soft keyboard and a screen to input letters disappear, and previous or next menu or another current menu to input another letters can appear. Here, the input letters of the current menu can be transmitted to and used in the control unit 220 and/or the functional unit 250 to perform a desired operation of the apparatus 200a of FIGS. 2 and 3 according to command or data corresponding to the input letters.

Movement between the soft keyboards 211, 212-1 to 212-6 may be performed by the manipulation of the left and right keys 233′ and 235′ of the four direction keys 230 illustrated in FIG. 3, but this is merely an exemplary embodiment of the present general inventive concept. The number of soft keys representing the input keys, the display areas and the functions thereof may not be limited.

While the display area and the input keys are horizontally arranged in this exemplary embodiment of the present general inventive concept, the display area and the input keys may be vertically arranged, and thus the functions of the four direction keys 232′ to 235′ may be changed to correspond to the arrangement of the display area and the input keys.

While the focus ring 211-1 is displayed around the display area and all of the input keys 211, 212-1 to 21-6 in this exemplary embodiment of the present general inventive concept, the focus ring 211-1 may be displayed around only the input keys 212-1 to 212-6, and not the display area 211. In this case, if the up and down direction keys 232′ and 234′ are manipulated even while the focus ring 211-1 is displayed around at least one of the input keys 212-1 to 212-6, the letter displayed on the display area 211 may be changed. It is possible to perform both the function of one of the input keys 212-1 to 212-6, around which the focus ring 211-1 is positioned and the function of changing a letter displayed on the display area 211.

If the input unit 230 is embodied as a search wheel which may be rolled, the letters displayed on the display area may change according to the roll of the wheel.

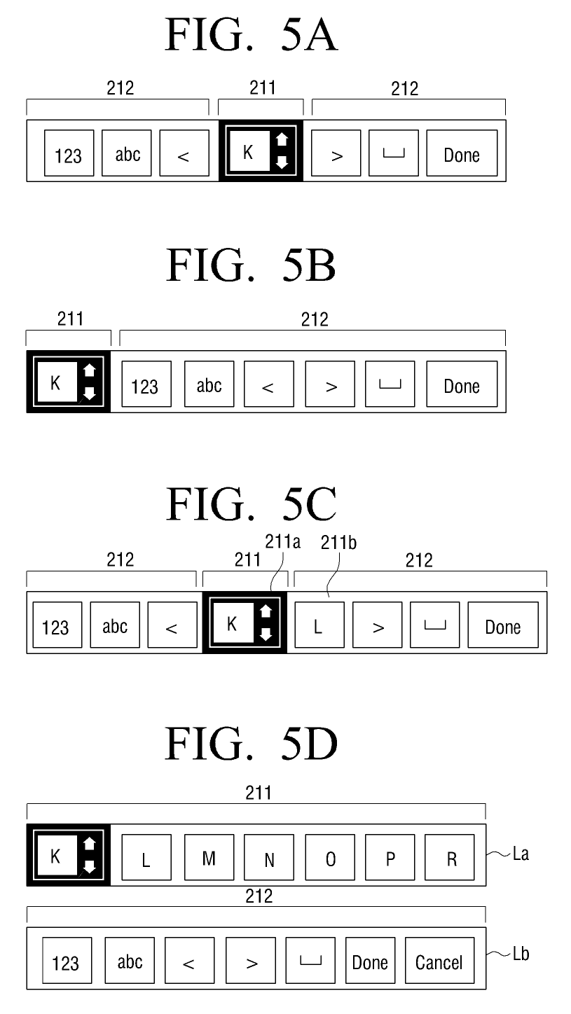

FIGS. 5A to 5D are views provided to explain arrangement of the first key and input keys according to various exemplary embodiments of the present general inventive concept.

The display area 211 may be positioned in the center of the input keys 212 as illustrated in FIG. 5A, or at the left or right edge of the input keys 212.

The display area 211 may be formed with sub-display areas 211a and 211b to display two letters at the same time as illustrated in FIG. 5C, or formed in a line La separate from a line Lb of the input keys 212 as illustrated in FIG. 5D.

The input keys 212 may include a cancel key to cancel the letter input as shown in FIG. 5D.

Referring to FIGS. 5C and 5D, when two or more letters are displayed concurrently, the mark [symbol] to change the letter is displayed on the foremost letter. However, this is merely exemplary, and the position of the mark [symbol] may vary. The mark [symbol] can be separated into an up mark and a down mark as illustrated in FIGS. 5A-5D and can select a desired letter according to a manipulation or selection of the up and down direction keys 232′ and 234′.

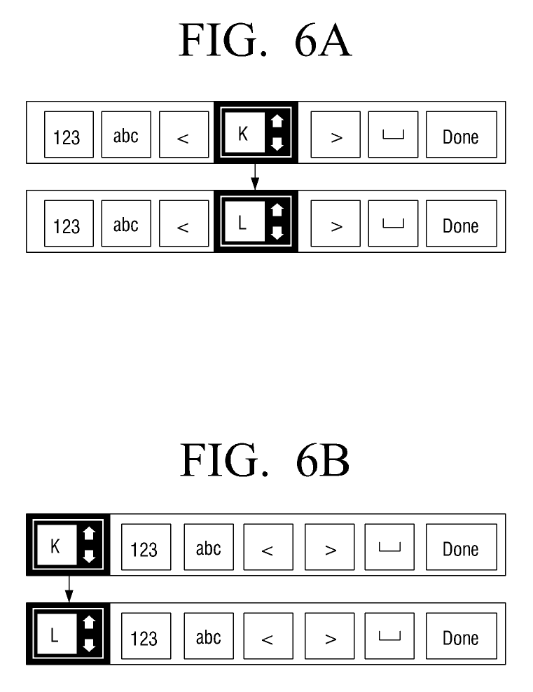

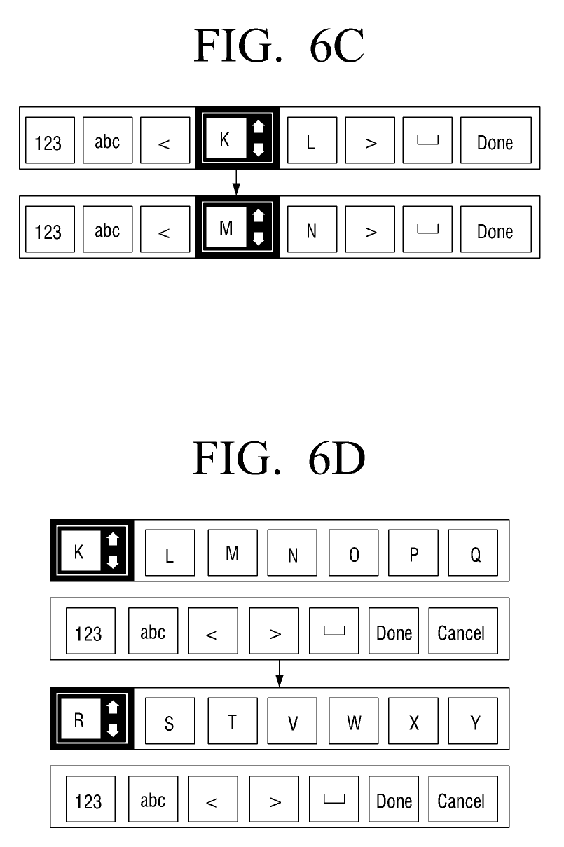

FIGS. 6A to 6D are views provided to explain the exemplary embodiments of FIG. 5A to 5D in detail.

The letter “K” displayed on the display area is changed to the following letter “L” by manipulation of the up and down direction keys 232′ and 234′ among the four direction keys 230′ of FIG. 3 as shown in FIGS. 6A and 6B.

If the letters “K” and “L” are displayed concurrently as shown in FIG. 6C, the following letters “M” and “N” are displayed by manipulation of the up and down direction keys 232′ and 234′ among the four direction keys 230′ of FIG. 3.

If the display area and the input keys are arranged in different lines as shown in FIG. 6D, the letters “K, L, M, N, O, P, Q” displayed on the display area are changed to the letters “R, S, T, V, W, X, Y” by manipulation of the up and down direction keys 232′ and 234′ among the four direction keys 230′ of FIG. 4.

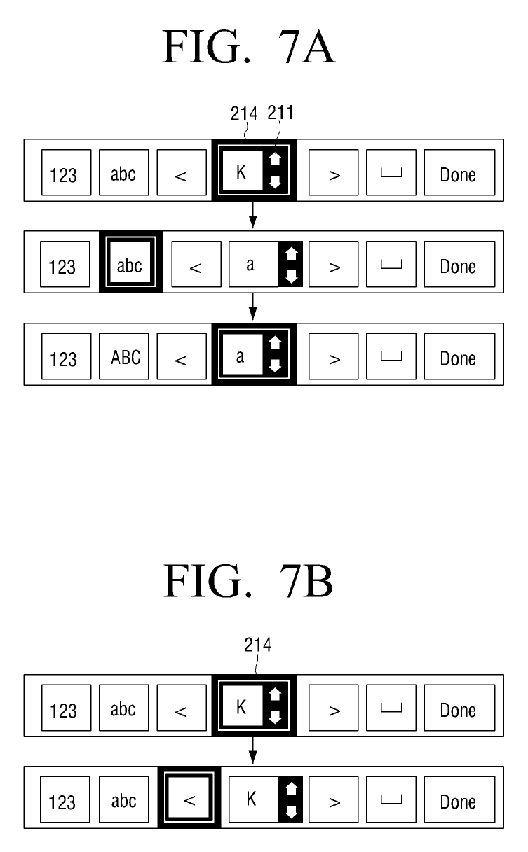

FIGS. 7A and 7B are views illustrating focus movement according to an exemplary embodiment of the present general inventive concept.

Referring to FIG. 7A, if the focus ring 214 moves to the lowercase key “abc” while being positioned on the display area 211, the focus ring 214 automatically returns to the display area 211 since the lowercase key “abc” corresponds to a one-time menu.

Referring to FIG. 7B, if the focus ring 214 moves to the key “<” to move the cursor on the display area 211, the focus ring 214 remains on the key “<” since the key “<” corresponds to a repetitive menu. The repetitive menu indicates a menu to repeat a function of the key. For example, when the key “<” is selected two times, the cursor 231′ can move by two positions (letters) of the input letters 213a in the intended direction.

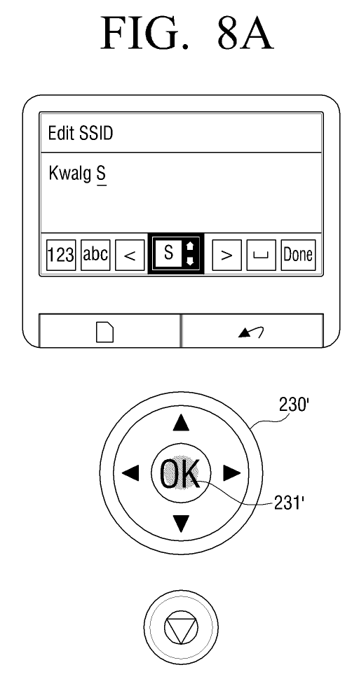

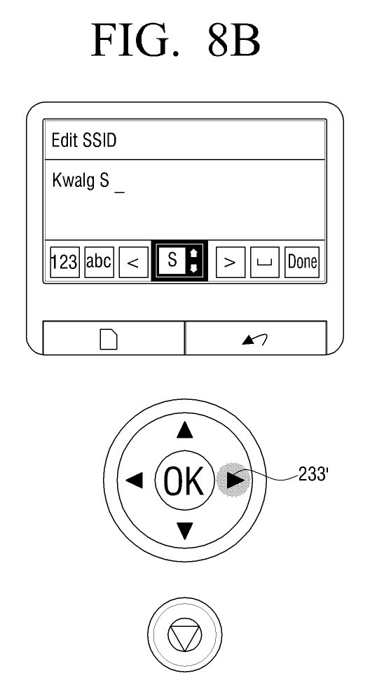

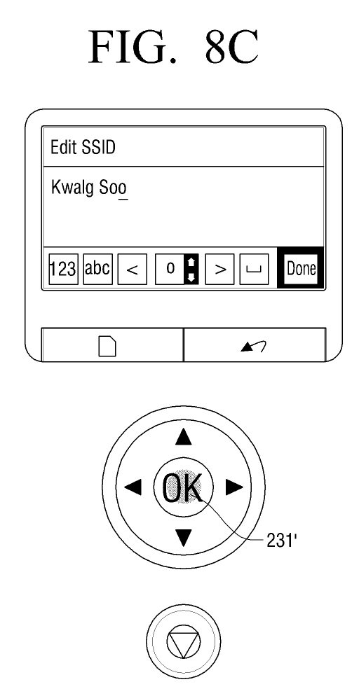

FIGS. 8A to 8C are views provided to explain a character input method using four direction keys according to an exemplary embodiment of the present general inventive concept.

Referring to FIG. 8A, if an OK key 231′ in the center of the four direction keys 230′ is selected while the letter “S” is displayed on the display area, the letter “S” is displayed on an input window, and a cursor displayed on the input window automatically moves to the right.

If the letter input is completed, the focus ring is moved to the key “Done” using the right direction key 233′ among the four direction keys 230′ as shown in FIG. 8B.

If the OK key 231′ is pressed while the focus ring is positioned on the key “Done” as shown in FIG. 8C, the letter input is terminated, and upper (or previous) menus are displayed.

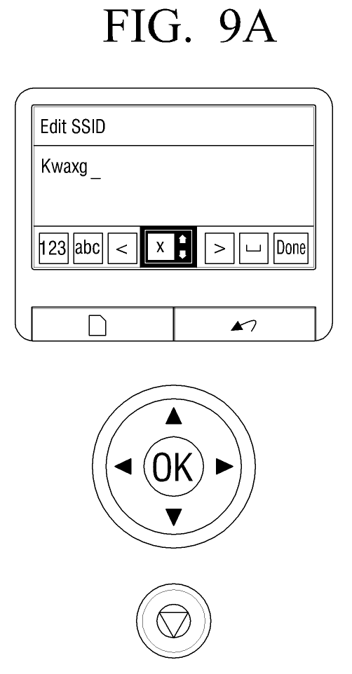

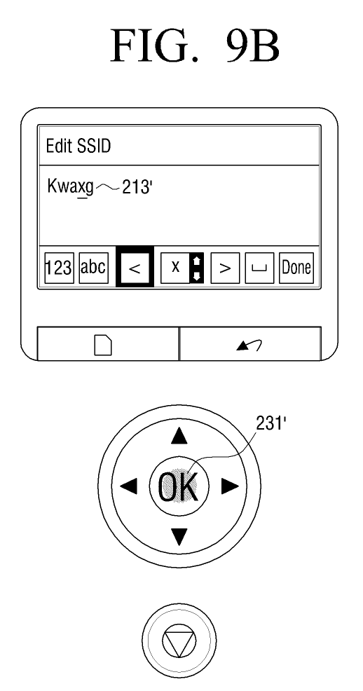

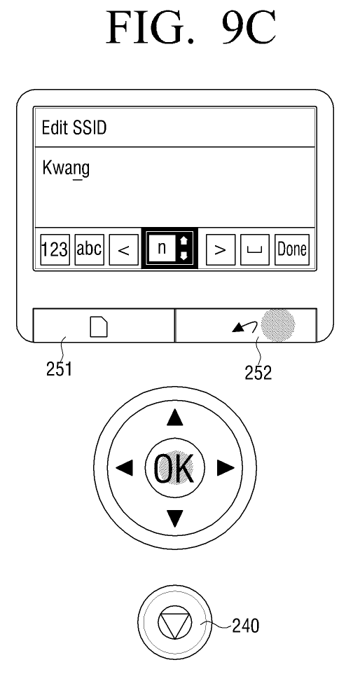

FIGS. 9A to 9B are views provided to explain a method for modifying input letters according to another exemplary embodiment of the present general inventive concept.

If a user desires to amend the input letter as shown while inputting letters in FIG. 9A, the user moves the focus ring to the key “<” among the input keys, and presses the OK key 231′ using the left direction key 235′, and thus the cursor is positioned over the letter “x” as illustrated in FIG. 9B. The letter displayed on the display area may be automatically changed to “x”, corresponding to the letter “x” over which the cursor 231′ is positioned.

The focus ring positioned over the key “<” returns to the display area when a predetermined time period has elapsed or when the corresponding key is manipulated.

The letter “n” is changed in the same manner as the letter is input while the focus ring is positioned on the display area as illustrated in FIG. 9C.

If a user desires to delete the input letter, the user places the cursor 231′ on the letter to be deleted, and presses a key [symbol] 252.

If a user desires to cancel input of the letter while inputting the letters, the user manipulates the cancel key 240 or a menu key 251 provided on the lower portion of the input unit 230, and thus the input letters are canceled, and upper (or previous) menus appear.

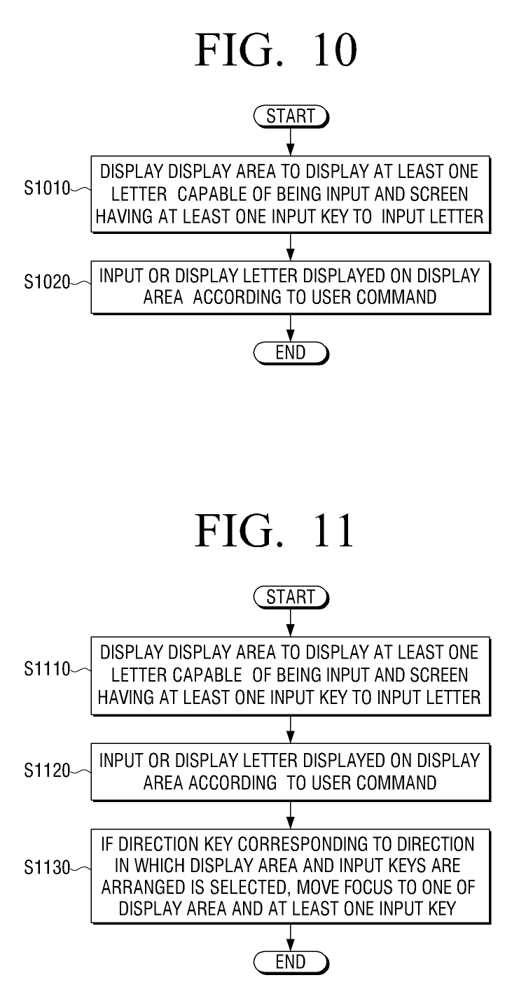

FIG. 10 a flowchart provided to explain a character input method according to an exemplary embodiment of the present general inventive concept.

Referring to FIG. 10, a display area to display at least one letter capable of being input and a screen having at least one input key to input a letter are displayed in operation S1010. The letter displayed on the display area is input or displayed according to a user command in operation S1020.

FIG. 11 is a flowchart provided to explain a character input method according to another exemplary embodiment of the present general inventive concept.

Referring to FIG. 11, a display area to display at least one letter capable of being input and a screen having at least one input key to input a letter are displayed in operation S1110. The letter displayed on the display area is input or displayed according to a user command in operation S1120.

If a direction key corresponding to the direction in which the display area and the input keys are arranged is selected from among the four direction keys, a focus is moved to the display area and at least one input key in the selected direction in operation S1130.

The process of inputting or displaying a letter may be the process of inputting or displaying the letter displayed on the display area according to manipulation of the first key which changes the letter displayed on the display area provided on an input device, and selects at least one input key, or the second key which confirms the letter displayed on the display area or the input key selected by the selection key.

The process of inputting or displaying a letter may be that if the first key is manipulated while a specific mode is selected, at least one letter supported by the specific mode is displayed on the display area according to the direction and number of times the first key is manipulated, and if the second key is selected while a specific letter is displayed on the display area, the specific letter is input.

If a direction key perpendicular to the direction in which the display area and the input keys are arranged is selected, the letter displayed on the display area may be changed.

If a one-time menu is selected while the focus is positioned on a one-time menu of the menus for at least one the input key, the focus may automatically return to the display area, and if a repetitive menu is selected while a focus is positioned on the repetitive menu of the menus for at least one the input key, the focus may be maintained on the current position.

The process of inputting or displaying a letter may include inputting or displaying a letter by changing the letter displayed on the display area by manipulation of a search wheel provided on the input device, or by selecting at least one input key.

The letters selected using the display area and a cursor indicating the position of the selected letter may be displayed on a screen.

If the conditions to input a letter are provided, a screen having the display area and at least one input key may appear automatically.

The display area and at least one input key may be formed transparently or semi-transparently.

The position of the display area and at least one input key may be swapped with each other.

According to exemplary embodiments of the present general inventive concept, letters may be input quickly and conveniently using a soft keyboard even on a narrow display.

A soft keyboard having a small number of letters uses little display space. A UI screen related to the environment required to input letters is provided as it is, and the number of input keys used to input letters is minimized. Therefore, the compatibility between letter input and the environment is improved.

According to the present general inventive concept, the letters or numbers are displayed in the display unit according to selection of the key of the input unit.28, and the key of the input unit is selected according to a movement thereof with respect to a body of the input unit

According to the present general inventive concept, the display unit has a dimension, and the input unit has another dimension not larger than the dimension of the display unit. It is possible that a sum of the first area and the second area of the display unit is not larger than the input unit in a direction on which the display unit and the input unit are disposed

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A letter input apparatus, comprising:
an input unit comprising at least one direction key;
a display unit to display a screen comprising a display area to display at least one of letters to be input using the input unit, and an area including at least one input key to input the at least one letter; and
a control unit to generate a signal corresponding to the input letter to be displayed on the display area.

2. The apparatus of claim 1, wherein the input unit further comprises an input unit comprising:
a first key to change a letter displayed on the display area, and to select the at least one input key; and
a second key to confirm the letter displayed on the display area or the input key selected by the first key.

3. The apparatus of claim 2, wherein if the first key is manipulated while a specific mode is selected, the control unit controls the display unit to display at least one letter supported by the specific mode on the display area according to a direction or number of times the first key is manipulated, and if the second key is manipulated while a specific letter is displayed on the display area, the specific letter is input.

4. The apparatus of claim 1, wherein the input unit comprises four direction keys, and if a direction key corresponding to a direction in which the display area and the input keys are arranged is selected from among the four direction keys, the control unit moves a focus to one of the display area and the at least one input key according to the selected direction.

5. The apparatus of claim 4, wherein if a direction key perpendicular to the direction in which the display area and the input keys are arranged is selected from among the four direction keys, the control unit changes the letter displayed on the display area.

6. The apparatus of claim 5, wherein if a one-time menu is selected while the focus is positioned on the one-time menu among menus for the at least one input key, the control unit automatically returns the focus to the display area, and if a repetitive menu is selected while the focus is positioned on the repetitive menu among menus for the at least one input key, the control unit keeps the focus on the current position.

7. The apparatus of claim 1, wherein the input unit comprises a search wheel, and the control unit changes a letter displayed on the display area according to the roll of the search wheel, or selects the at least one input key.

8. The apparatus of claim 1, wherein the display unit comprises a screen on which the letter selected on the display area and a cursor indicating the position of the selected letter are displayed.

9. The apparatus of claim 1, wherein if conditions to input a letter are provided, the control unit automatically calls for a screen on which the display area and the at least one input are arranged.

10. A letter input method of a letter input apparatus, the method comprising:
displaying a screen comprising a display area to display at least one letter capable of being input by the input unit and at least one input key to input letters; and
inputting or displaying a letter displayed on the display area according to a user command.

11. The method of claim 10, wherein the inputting or displaying comprises:
inputting or displaying a letter displayed on the display area according to manipulation of at least one of a first key to change a letter displayed on the display area, and to select the at least one input key and a second key to confirm the letter displayed on the display area or the input key selected by the first key.

12. The method of claim 11, wherein if the first key is manipulated while a specific mode is selected, the inputting or displaying displays at least one letter supported by the specific mode on the display area according to the direction or number of times the first key is manipulated, and if the second key is manipulated while a specific letter is displayed on the display area, the inputting or displaying inputs or displays the specific letter.

13. The method of claim 10, further comprising:
displaying a focus on at least one of the display area and the at least one input key; and
if a direction key corresponding to a direction in which the display area and the input keys are arranged is selected from among the four direction keys provided on the letter input apparatus, moving a focus according to the selected direction.

14. The method of claim 13, further comprising:
if a direction key perpendicular to the direction in which the display area and the input keys are arranged is selected from among four direction keys, changing the letter displayed on the display area.

15. The method of claim 14, further comprising:
if a one-time menu is selected while the focus is positioned on the one-time menu among menus for the at least one input key, automatically returning the focus to the display area; and
if a repetitive menu is selected while the focus is positioned on the repetitive menu among menus for the at least one input key, keeping the focus on the current position.

16. The method of claim 10, wherein the inputting or displaying comprises:
changing a letter displayed on the display area according to the roll of a search wheel provided on the letter input apparatus, or selecting the at least one input key in order to input or display the letter.

17. The method of claim 10, further comprising:
displaying the letter selected on the display area and a cursor indicating the position of the selected letter on the screen.

18. The method of claim 10, wherein if conditions to input a letter is provided, automatically calling for a screen on which the display area and the at least one input are arranged.

19. The method of claim 10, wherein the display area and the at least one input key are disposed horizontally or vertically on the screen.

20. The method of claim 10, wherein the display area and the at least one input key are displayed transparently or semi-transparently.

21. The method of claim 10, wherein the positions of the display and the at least one input key are swapped with each other.

22. An apparatus comprising:
a letter input apparatus, comprising:
an input unit comprising at least one direction key,
a display unit to display a screen comprising a display area to display at least one letter capable of being input using the input unit and at least one input key to input letters, and
a control unit to cause the letter displayed on the display area to be input or displayed; and
a unit to perform an operation according to data corresponding to the input letter of the input apparatus.

23. An input device comprising, comprising:
a display unit having a screen a first area to display at least one of characters, a second area to display a direction to indicate another one of the characters, and a third area to display at least one of the at least one and the another one of the characters; and
an input unit having a first key to select the displayed direction and a second key to select the at least one character such that the third area of the display unit displays the selected at least one character.
